(19) United States
(12) Patent Application Publication
(10) Pub. No.: US 2007/0224459 A1
(43) Pub. Date: Sep. 27, 2007

(54) Magnetic recording medium including carbon nanotubes

(76) Inventors: Meng C. Hsieh, Woodbury, MN (US); Andrei Potanin, Hillsborough, NJ (US)

Correspondence Address: IMATION CORP., P.O. BOX 64898, ST. PAUL, MN, 55164-0898, US

(21) Appl. No.: 11/388,699

(22) Filed: Mar. 24, 2006

(51) Int. Cl. G11B 5/706

(52) U.S. Cl. 428/844; 428/845.2

(57) ABSTRACT

A magnetic recording medium including a substrate having a front side and a backside, having at least a magnetic recording layer coating the front side, and possibly an optional support layer or sublayer, wherein at least one layer of the magnetic recording medium includes carbon nanotubes.

### THE FIELD OF THE INVENTION

The present invention relates generally to a magnetic recording medium including at least a magnetic recording layer, and more specifically to a magnetic recording medium having at least one magnetic recording layer, optionally a support layer therefore, in which the magnetic recording layer or the support layer, if present, contains carbon nanotubes.

### BACKGROUND OF THE INVENTION

Magnetic recording media are widely used in audiotapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, such magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium.

Particulate-based magnetic recording media include a granular pigment. Popular pigments are metal oxides, ferromagnetic metal oxides, and ferromagnetic metal alloys. Different pigments have different surface properties; the metal particles often have a strongly basic surface. Recording media often utilize ferromagnetic particles in the formulations such as gamma iron oxide (γ-Fe₂O₃), magnetite (Fe₃O₄), cobalt-doped iron oxides, or ferromagnetic metal or metal alloy powders, along with carbon black particles.

In certain designs, the magnetic coating is formed as a single thin layer directly onto a non-magnetic substrate. However, many magnetic recording media now form the front coating as a dual layer construction, including a support layer or sublayer formed on the substrate and a thin magnetic recording layer or upper layer formed directly on the support or lower layer. With this construction, the support layer is typically non-magnetic or substantially non-magnetic, generally comprised of at least one non-magnetic powder and a binder. Conversely, the magnetic recording layer comprises a magnetic metal particle powder or pigment dispersed in a polymeric binder. Both the magnetic recording layer and the support layer of dual layer magnetic recording media typically include a binder composition or binder system. The binder system performs such functions as dispersing the particulate materials, increasing adhesion between layers and to the substrate, improving gloss and the like. As might be expected, the formulation specifics as well as coating of the binder compositions to an appropriate substrate are highly complex, and vary from manufacturer to manufacturer; however, most binders include such materials as thermoplastic materials.

Magnetic recording media may also have a backside coating applied to the opposing side of the non-magnetic substrate in order to improve the durability, conductivity, and tracking characteristics of the media.

One relatively new type of macromolecule is known as a carbon nanotube. Carbon nanotubes are large macromolecules of unique shape. They are long thin cylinders of carbon, which are often described as analogous to a hexagonal lattice of carbon rolled into a cylinder, and have a hemispherical “cap” at the end of the cylinder. The nanotubes may include single cylindrical walls or multiple cylindrical walls, i.e., cylinders inside of cylinders. Nanotubes are very strong, are light stable and thermally stable, and chemically inert.

For the first time, it has now been discovered that carbon nanotubes may be useful in coatings for magnetic recording media.

### SUMMARY OF THE INVENTION

The invention provides a magnetic recording medium wherein at least one layer comprises carbon nanotubes.

More specifically, the invention provides a single layer magnetic recording medium in which the magnetic recording layer contains carbon nanotubes, and further provides a dual-layer magnetic recording medium wherein at least one of the layers comprises carbon nanotubes.

In one embodiment, the invention provides a magnetic recording medium comprising a substrate having coated thereon a front coat having at least one coating containing a pigment and a binder system therefore, wherein the coating contains carbon nanotubes.

In another embodiment, the magnetic recording medium is a dual layer magnetic recording medium comprising a substrate having a front coat coated on one surface thereof, wherein said front coat comprises a magnetic recording layer and a support layer, wherein at least one of said magnetic recording layer and the support layer comprises carbon nanotubes.

In another embodiment, the magnetic recording medium is a dual layer magnetic recording medium having a magnetic recording layer and a support layer wherein the support comprises carbon nanotubes.

In another embodiment, the magnetic recording medium is a dual layer magnetic recording medium having a magnetic recording layer and a support layer wherein both the magnetic recording layer and the support layer comprise carbon nanotubes,

In another embodiment, the magnetic recording medium is a single layer magnetic recording medium comprising a substrate having a front coat coated on one surface thereof, wherein the front coat comprises a sole layer which is a magnetic recording layer, such magnetic recording layer comprising carbon nanotubes.

The magnetic recording medium may be a magnetic recording tape. Such magnetic recording tape may be single layer or dual-layer.

These terms when used herein have the following meanings.

1. The term “carbon nanotube(s)” is used to mean macromolecules of carbon, coiled into cylinders, including single cylindrical wall tubes (SWNTs) and multiple cylindrical wall tubes (MWNTs).

2. The term “coating composition” means a composition suitable for coating onto a substrate.

3. The term “coating” refers to a coated composition or compound.

4. The term “layer” refers to a film or a coated or deposited compound or composition placed on a substrate or atop another layer.

5. The term “coercivity” means the intensity of the magnetic field needed to reduce the magnetization of a ferromagnetic material to zero after it has reached saturation, taken at a saturation field strength of 10,000 Oersteds.

6. The term “Oersted”, abbreviated as Oe, refers to a unit of magnetic field equal to (¼πn) kA/m.

7. The terms “coated composition” refers to a composition which includes one or more compounds, which may be the result of one or more evaporative processes and one or more passages through the coating apparatus.

8. The term “squareness” is defined as the ratio of the sample's moment at zero field after saturation with a field of 10000 Oe, to the moment at 10000 Oe, when measured and saturated in the direction parallel to the tape length.

9. The term “remanence-thickness product” or Mr*t is defined as the moment per unit tape area, measured in memu/cm², measured at zero field after saturation in a field of 10000 Oe, with both measurement and saturation parallel to the tape length.

### BRIEF DESCRIPTION OF THE DRAWINGS

FIG. 1 is a graph of the parts per hundred oxide of carbon present in sublayer formulations plotted against the resistance of the layer.

### DETAILED DESCRIPTION OF THE PREFERRED EMBODIMENTS

The invention provides a magnetic recording medium including a non-magnetic substrate having a front coat coated onto the front side of the substrate wherein at least one of the coatings comprises carbon nanotubes.

The magnetic recording medium may be a magnetic recording tape, and may contain only a single layer in the front coat, i.e., a magnetic recording layer, or the front coat may contain multiple layers such as a magnetic recording layer and one or more support layers.

### Carbon Nanotubes

Carbon nanotubes are long thin cylinders of carbon which were discovered in 1991. They are large macromolecules which can be thought of as a sheet of hexagonal carbon lattice rolled into a cylinder. Nanotubes are available in different types, including cylinders having single cylindrical wall tubes (SWNTs) and multiple cylindrical wall tubes (MWNTs), essentially cylinders inside other cylinders. The basic structure of a nanotube, especially a SWNT type of nanotube, can also be described by diameter, length and twist, or chiral vector (n, m), where n and m are integers of the vector equation R=na₁+ma₂. The values of n and m determine the twist or chirality of the nanotube, which in turn affects the conductivity, density, and lattice structure of the nanotube. The average diameter of a SWNT is 1.2-1.4 nm, however, nanotubes vary in size, and larger nanotubes bend somewhat under their own weight and so aren't perfectly cylindrical. A SWNT is considered metallic, and therefore conducting, if the value of n-m is divisible by three, otherwise the nanotube is semiconducting. Therefore, nanotubes formed randomly will be two-thirds semi-conducting, and one third metallic. Resistivity is about 10⁻⁴-cm.

SWNT nanotubes are stronger than steel, and have somewhat elastic behavior, with an average Young's Modulus of approximately 1 TPa, and a maximum tensile strength of about 30 GPa. The average Young's modulus of MWNT nanotubes has been estimated as approximately 1.28 TPa to approximately 1.8 TPA.

When used in magnetic recording media coatings of the invention, carbon nanotubes can reduce resistivity without the accompanying problems of using carbon black, which has traditionally been used along with particulate pigments in such coating layers.

### Magnetic Recording Medium

The magnetic recording medium of the invention includes at least one magnetic recording layer. The magnetic recording layer or layers are thin, being preferably from about 0.025 micron (μ), or one microinch, to about 0.25μ, or about 10 microinches in thickness, preferably up to about 0.20μ. Magnetic recording layers of the invention include at least one type of magnetic particulate material. Useful magnetic pigments have compositions including, but not limited to, metallic iron and/or alloys of iron with cobalt and/or nickel, and magnetic or non-magnetic oxides of iron, other elements, or mixtures thereof. Alternatively, the magnetic particles can be composed of hexagonal ferrites, such as barium ferrites, can be composed of partially or completely iron nitride composition, or can be nanoparticles of, e.g., cobalt, CoPt, or FePt composition. Metallic or metal nitride particles typically have passivation shells of oxides or other materials. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Pigments have an average particle length of preferably 100 nanometers (nm) or less, more preferably 60 nm or less, still more preferably 45 nm or less. Such pigments are available from companies such as Toda Kogyo and Dowa Mining Company. Non-acicular particles can have average diameters of from 8 nm to about 35 nm. As noted above, pigments useful in magnetic recording media of the invention have a minimum coercivity of at least about 2000 Oe.

In current dual-layer technology, the sublayer provides the conductivity for the media. If there is no sublayer, as in a single layer magnetic recording medium, the resistivity of the media increases which causes static buildup on the media. Such static buildup may cause head failures when the static discharges during use. Low resistivity may be achieved using conventional carbon black but a high level of carbon black would be required to reach the desired resistivity. High loadings of carbon black tend to have undesirable effects on the parametrics and defect levels of the magnetic recording medium. Inclusion of the carbon nanotubes in the magnetic recording layer will give the magnetic recording layer sufficient conductivity at a heretofore not possible low carbon loading.

A single layer embodiment of a magnetic recording tape may include up to about 2 parts by weight of carbon nanotubes per 100 parts by weight of pigment in the single layer, the magnetic recording layer. Such addition will allow more effective use of a carbon material in a thin single layer magnetic recording tape. Such tapes will have better conductivity and/or improved data recording properties over magnetic recording tapes having magnetic layers including carbon particles, as higher quantities particulate material would be required to achieve the same conductivity as the carbon nanotubes.

In a dual-layer embodiment, the magnetic layer may include carbon nanotubes or soft spherical carbon black particles. If carbon black is used in the magnetic recording layer of a dual-layer magnetic recording medium, the size of the carbon particles present in the layer are small carbon particles, i.e., the particles have a particle size on the order of less than 100 nm, preferably less than about 50 nm. A small amount, preferably less than about 3%, of at least one relatively large particulate carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance.

If carbon nanotubes are used in the magnetic recording layer of a dual-layer magnetic recording medium, the magnetic recording layer may include up to about 2 parts by weight of carbon nanotubes per 100 parts by weight of pigment in the magnetic recording layer

The polymeric binder system or resin associated with the magnetic layer incorporates resin binders, a surfactant (or wetting agent), a head cleaning agent and one or more hardeners. In one embodiment, the binder system of the magnetic recording layer includes at least one vinyl resin that is a non-halogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 5 to 30 parts by weight of a nonhalogenated hydroxyl functional, vinyl monomer, and 0.25 to 10 parts of a nonhalogenated, vinyl monomer bearing a dispersing group.

In a preferred embodiment, the resin binder is incorporated into the magnetic layer in amounts of from about 3 parts to about 12 parts by weight, and preferably from about 7 parts to about 10 parts by weight, based on 100 parts by weight of the primary pigment in the magnetic layer. In one embodiment, the vinyl binder or vinyl chloride binder is incorporated into the magnetic layer in amounts of from about 3 parts to about 15 parts by weight, and preferably from about 5 to about 11 parts by weight, based on 100 parts by weight of the primary pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable.

The binder system may also contain a conventional surface treatment agent. Known surface treatment agents, such as phenylphosphonic acid (PPA), 4-nitrobenzoic acid, and various other adducts of sulfuric, sulfonic, phosphoric, phosphonic, and carboxylic acids are acceptable.

The binder system may also contain a hardening agent such as isocyanate or polyisocyanate crosslinker. In a preferred embodiment, the hardener component is incorporated into the sublayer in amounts of up to about 5 parts by weight.

The magnetic layer may further contain one or more lubricants such as a fatty acid and/or a fatty acid ester. The incorporated lubricant(s) exist throughout the front coating and, importantly, at the surface of the upper layer. The lubricant(s) reduces friction to maintain smooth contact with low drag, and protects the media surface from wear. Thus, the lubricant(s) provided in the upper magnetic layer, and any sublayer present are preferably selected and formulated in combination.

### Sublayer

The optional sublayer or support layer of a multi-layer magnetic tape is essentially non-magnetic and typically includes a non-magnetic or soft magnetic powder having a coercivity of less than 300 Oe and a polymeric binder system containing pendant hydroxyl groups. By forming the sublayer to be essentially non-magnetic, the electromagnetic characteristics of the upper magnetic layer are not adversely affected. However, to the extent that it does not create any adverse affect, the sublayer may contain a small amount of a magnetic powder.

In dual-layer magnetic recording media of the invention, the pigment or powder incorporated in the sublayer includes carbon nanotubes and may further include particulate pigments such as carbon black or non-magnetic particles such as iron oxides, titanium dioxide, alumina, tin oxide, titanium carbide, silicon carbide, silicon dioxide, silicon nitride, boron nitride, etc., and soft magnetic particles having a coercivity of less than 300 Oe.

The pigment or powder incorporated in the sublayer includes at least a primary pigment material and a carbon material. In a preferred embodiment, the carbon material is carbon nanotubes. The primary pigment material consists of a particulate material, or “particle” selected from non-magnetic particles such as iron oxides, titanium dioxide, alumina, tin oxide, titanium carbide, silicon carbide, silicon dioxide, silicon nitride, boron nitride, etc., and soft magnetic particles having a coercivity of less than 300 Oe. Optionally, these primary pigment materials can be provided in a form coated with carbon, tin, or other electroconductive material and employed as sublayer pigments. In a preferred embodiment, the primary sublayer pigment material is a carbon-coated hematite material (a-iron oxide), which can be acidic or basic in nature. Preferred alpha-iron oxides are substantially uniform in particle size, or a metal-use starting material that is dehydrated by heating, and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, KDK, Sakai Chemical Industry Co, and others. The primary pigment preferably has an average particle size of less than about 0.25 μm, more preferably less than about 0.15 μm.

Traditionally, conductive carbon black material has been used to provide a certain level of resistance so as to prohibit the front coating from charging with static electricity. It is desirable to provide a sublayer having a resistance on an order of about 1E6 Ohm/square.

In one embodiment of magnetic recording media of the invention, the sublayer comprises carbon nanotubes rather than the conventional carbon black. The carbon nanotubes are added in amounts of up to about 5 parts, preferably from about 1 part to about 2 parts, based on 100 parts by weight of the primary pigment in the sublayer. Conventional carbon black materials are traditionally added in amounts of from about 1 to about 25 parts by weight, based on 100 parts by weight of the primary sublayer pigment material, depending on the particle size and conductive nature of the carbon pigment used.

Use of carbon nanotubes in the sublayer allows the reduction of carbon addition of the layer about 20% or less than the carbon required to achieve the same conductivity with particulate carbon material. Since carbon black is difficult to disperse, this reduces process issues for the coating. This reduction significantly improves coating quality and reduces the amount of defects in the coating.

The sublayer can also include additional pigment components such as an abrasive or head-cleaning agent (HCA). One preferred HCA component is aluminum oxide. Other abrasive grains such as silica, ZrO₂, Cr₂O₃, etc., can be employed.

The polymeric binder system or resin associated with the sublayer may incorporate at least one polymeric binder containing pendant hydroxyl groups, such as a thermoplastic resin, in conjunction with other resin components such as binders and surfactants used to disperse the HCA, a surfactant (or wetting agent), and one or more hardeners. In one embodiment, the binder system of the sublayer includes a combination of a primary polyurethane resin and a vinyl chloride resin, a vinyl chloride-vinyl acetate copolymer, vinyl chloride-vinyl acetate-vinyl alcohol copolymer, vinyl chloride-vinyl acetate-maleic anhydride, or the like. In an alternate embodiment, the vinyl resin is a non-halogenated vinyl copolymer. Useful vinyl copolymers include copolymers of monomers comprising (meth)acrylonitrile; a nonhalogenated, hydroxyl functional vinyl monomer; a nonhalogenated vinyl monomer bearing a dispersing group, and one or more nonhalogenated nondispersing vinyl monomers. A preferred nonhalogenated vinyl copolymer is a copolymer of monomers comprising 5 to 40 parts of (meth)acrylonitrile, 30 to 80 parts of one or more nonhalogenated, nondispersing, vinyl monomers, 5 to 30 parts by weight of a nonhalogenated hydroxyl functional, vinyl monomer, and 0.25 to 10 parts of a nonhalogenated, vinyl monomer bearing a dispersing group. Useful polyurethanes are described in the description of the magnetic layer.

In one embodiment, a primary polymeric binder with pendant hydroxyl groups is incorporated into the sublayer in amounts of from about 4 to about 10 parts by weight, and preferably from about 6 to about 8 parts by weight, based on 100 parts by weight of the primary sublayer pigment. In a preferred embodiment, the vinyl binder or vinyl chloride binder is incorporated into the sublayer in amounts of from about 7 to about 15 parts by weight, and preferably from about 10 to about 12 parts by weight, based on 100 parts by weight of the primary sublayer pigment.

The binder system for the sublayer may further include an HCA binder, a hardener, one or more lubricants, surface treatment agents and other adjuvants.

The materials for the sublayer are mixed with the surface treated primary pigment and the sublayer is coated to the substrate. Useful solvents associated with the sublayer coating material preferably include cyclohexanone (CHO), with a preferred concentration of from about 5% to about 50%, methyl ethyl ketone (MEK) preferably having a concentration of from about 30% to about 90%, and toluene (Tol) of concentrations from about 0% to about 40%. Alternatively, other ratios can be employed, or even other solvents or solvent combinations including, for example, xylene, tetrahydrofuran, and methyl amyl ketone, are acceptable.

### Backcoat

In certain embodiments of the magnetic recording medium of the invention, the substrate also has a backcoat. A backcoat is a coating coated on the opposite side of the substrate as the magnetic coating or front coat. The backcoat primarily consists of a soft (i.e., Moh's hardness <5) non-magnetic particle material such as carbon black. In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 25 nm, whereas the secondary, large carbon component preferably has an average particle size on the order of from about 50 to about 300 nm. As is known in the art, back coat pigments dispersed as inks with appropriate binders, surfactant, ancillary particles, and solvents are typically purchased from a designated supplier. In a preferred embodiment, the back coat binder includes at least one of: a polyurethane polymer, a phenoxy resin, or nitrocellulose added in an amount appropriate to modify coating stiffness as desired.

In an alternate embodiment, a back coat may contain at least one non-magnetic particle material such as carbon black, iron oxides, titanium dioxide, alumina, tin oxide, titanium carbide, silicon carbide, silicon dioxide, silicon nitride, boron nitride, and the like. This back coat formulation preferably contains from about 2% to about 6% by weight percent carbon. The backcoat preferably includes a mixture of pigments including carbon black, and from about 47% to about 63% by weight of alpha iron oxide, and from about 0.5% to about 6% of alumina, along with from about 13% to about 25% of titanium dioxide. The back coat also contains a polymeric binder system containing pendant hydroxyl groups.

### EXAMPLES 1-2, AND COMPARATIVE EXAMPLES C3-C4

Six coatings were made from quick-milled support layers. All of the coatings contained DB65 as the iron oxide. For the coatings of Examples 1 and 2, SWNT carbon nanotubes were added. The nanotubes were obtained as XD3365A, from CNI. Example 1 was prepared using a similar process to that normally used to add carbon black, i.e., the SWNT nanotubes were added to the iron oxide as a powder together with phenyl-polyphosphynic acid (PPiA). Example 2 was prepared by pre-dispersing the SWNT nanotube in methylethylketone (MEK) with addition of Disperbyk 2000 (a dispersant aid available from BYK Chemie) in a 1:1 ratio with the nanotubes. The dispersions were ultrasonicated for 15 minutes and added to the iron oxide samples. Formulations also included MR104 polyvinylchloride (available from Nippon Zeon K.K.) and UR 4125 polyurethane in a 1.33:1 ratio. The samples were milled by shaking with SEPR milling media (ceramic beads) for 15 hours.

Example C3 was prepared using carbon black EC600 and Example C4 was prepared using carbon black BP2000, a less conductive carbon black. These powders were added with two surface modifiers, PPiA and chrome orange and formulations were completed in the same fashion, and then milled as described for Examples 1 and 2. The level of carbon in the final mix for each formulation was measured in parts per hundred of oxide (ppho), by weight.

After milling, all samples were separated from the milling media by filtering through 5 micron filters, and hand coated onto polymeric substrates. One half inch tapes were cut, surface treated by calendering and resistivity was measured.

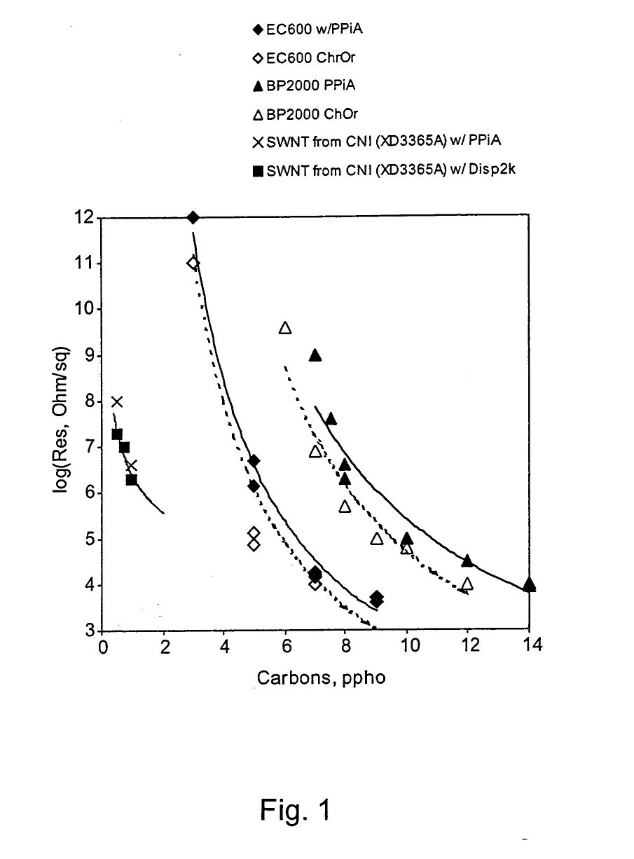

As FIG. 1 shows, the resistance for the sublayers of Examples 1 and 2 containing from 1-2 ppho carbon provided by carbon nanotubes was in the desired range, whereas Examples C3 and C4 containing carbon black required from 5-10 ppho carbon to achieve the same resistivity.

What is claimed is:

1. A magnetic recording medium comprising a non-magnetic substrate having a front side and a backside, comprises at least one magnetic recording layer on said front side, said layer including at least one magnetic pigment and a binder system therefore, said coating further comprising carbon nanotubes.

2. A magnetic recording medium according to claim 1, wherein said carbon nanotubes have a single cylinder.

3. A magnetic recording medium according to claim 1, wherein said carbon nanotubes have multiple cylinders.

4. A magnetic recording medium according to claim 1, wherein said magnetic recording layer includes from up to about 2 parts by weight of carbon nanotubes per 100 parts of magnetic pigment.

5. A magnetic recording medium according to claim 4, wherein said magnetic pigment is a ferromagnetic pigment.

6. A magnetic recording medium according to claim 4, wherein said magnetic pigment comprises acicular particles of iron or iron alloy and at least one other metal, said particles having a passivation shell.

7. A magnetic recording medium according to claim 1, wherein said coating is a magnetic coating comprising a magnetic pigment having a coercivity of at least about 2000 Oe.

8. A magnetic recording medium according to claim 5, wherein said magnetic recording layer comprises magnetic recording particles having a coercivity of at least about 2500 Oe.

9. A magnetic recording medium according to claim 1, wherein said substrate is selected from the group consisting of polyethylene terephthalate, polyethylene naphthalate, a mixture of polyethylene terephthalate and polyethylene naphthalate; polyolefins; cellulose derivatives; polyamides, and polyimides.

10. A magnetic recording medium according to claim 2, wherein the magnetic layer comprises a ferromagnetic pigment, aluminum oxide, a particulate carbon material, a polyurethane binder, a vinyl binder, a hardener, a fatty acid ester lubricant, and a fatty acid lubricant.

11. A magnetic recording medium according to claim 1, wherein said magnetic recording medium comprises only a single coating comprising a magnetic recording layer, wherein said carbon nanotubes are present in said magnetic recording layer.

12. A magnetic recording medium according to claim 1, wherein said coating on said front side includes at least a magnetic recording layer and a support layer.

13. A magnetic recording medium according to claim 12, wherein said carbon nanotubes are present in said support layer.

14. A magnetic recording medium according to claim 12, wherein said carbon nanotubes have a single cylinder.

15. A magnetic recording medium according to claim 12, wherein said carbon nanotubes have multiple cylinders.

16. A magnetic recording medium according to claim 11, wherein said support layer further comprises a nonmagnetic pigment and a binder therefore, and comprises from about up to about 2 parts by weight of carbon nanotubes per 100 parts of nonmagnetic pigment.

17. A magnetic recording medium according to claim 1, further comprising a coating on said backside of said substrate.
